(19) United States
(12) Patent Application Publication
(10) Pub. No.: US 2023/0198300 A1
(43) Pub. Date: Jun. 22, 2023

(54) WIRELESS CHARGING DEVICE

(71) Applicant: Primax Electronics Ltd., Taipei (TW)

(72) Inventor: Zheng-Mao Zhang, Taipei (TW)

(21) Appl. No.: 17/669,205

(22) Filed: Feb. 10, 2022

(30) Foreign Application Priority Data
Dec. 17, 2021 (CN) 202111551617.9

(51) Int. Cl. H02J 50/00; H02J 7/00; H02J 50/10

(52) U.S. Cl. CPC H02J 50/005; H02J 7/0042; H02J 50/10

(57) ABSTRACT

A wireless charging device includes a housing, a coil module and a magnetic attraction module. The coil module and the magnetic attraction module are accommodated within the housing. The magnetic attraction module can be moved upwardly or downwardly relative to the coil module. Consequently, the magnetic attraction force is adjustable according to the altitude adjustment of the coil module.

### FIELD OF THE INVENTION

The present invention relates to a charging device for charging a portable electronic device, and more particularly to a wireless charging device.

### BACKGROUND OF THE INVENTION

In modern societies, portable electronic devices (e.g., smart phones) become indispensable parts in human lives. The portable electronic devices are applied in many sectors, including food, clothing, housing, transportation, education and entertainment. Generally, the portable electronic device is powered by a built-in battery. When the electricity quantity of the battery is insufficient, it is necessary to charge the battery of the portable electronic device. Consequently, the portable electronic device can be continuously operated.

Nowadays, portable electronic devices can be charged by using a wired charging technology or a wireless charging technology. With the advancement of the wireless charging technology, a wireless charging module has gradually become one of the standard equipment of the portable electronic devices. For charging a portable electronic device, the portable electronic device is firstly placed on a wireless charging device. Then, a transmitter coil in the wireless charging device is enabled to emit an electromagnetic field. When an induction coil in the portable electronic device senses the electromagnetic field, a charging current is generated according to the change of the magnetic fluxes. Consequently, the portable electronic device is charged by the charging current.

Moreover, in order to facilitate the user to perform wireless charging operations in different use scenarios, the wireless charging device is usually equipped with a magnetic attraction module. When the portable electronic device is placed on the wireless charging device, the portable electronic device is magnetically attracted by the magnetic attraction module. Consequently, the portable electronic device can be securely placed on the wireless charging device.

However, since the types and specifications of the portable electronic devices are diverse, some problems occur. For example, since the built-in magnetic attraction module of the wireless charging device is usually able to generate a single-strength magnetic attraction force, the use of the wireless charging device leads to a lot of inconvenience. In case that the portable electronic device with the general protective case (i.e., the protective case without the magnetic attraction function) is placed on the wireless charging device by the user, the distance between the magnetic attraction module and the portable electronic device increases. Consequently, the magnetic attraction force between the magnetic attraction module and the portable electronic device decreases. Under this circumstance, the portable electronic device is prone to fall off from the wireless charging device, which affects the wireless charging efficiency.

Moreover, in case that the built-in magnetic attraction module of the wireless charging device is specially designed for the portable electronic device with the general protective case, other problems occur. If the portable electronic device without any protective case is placed on the wireless charging device or the portable electronic device with the protective case having the magnetic attraction function is placed on the wireless charging device, the magnetic attraction force between the magnetic attraction module and the portable electronic device is very strong. Under this circumstance, it is difficult for the user to remove the portable electronic device from the wireless charging device.

In order to overcome the drawbacks of the conventional technologies, there is a need of providing a wireless charging device whose built-in magnetic attraction module is applicable to different types and specifications of portable electronic device.

### SUMMARY OF THE INVENTION

The present invention provides a wireless charging device. The built-in magnetic attraction module of the wireless charging device is applicable to different types and specifications of portable electronic devices.

In accordance with an aspect of the present invention, a wireless charging device is provided. The wireless charging device includes a housing, a coil module and a magnetic attraction module. The housing includes an upper cover and a lower cover. Moreover, at least one push rib is formed on an inner surface of the lower cover. The coil module is installed on the lower cover. The coil module includes a coil bracket and a transmitter coil, wherein the coil bracket is fixed on the lower cover, and the transmitter coil is installed on the coil bracket. The magnetic attraction module is arranged around the coil module. The magnetic attraction module includes a movable bracket and a magnetic element. The movable bracket is rotatably installed on the lower cover. A lateral edge of the movable bracket includes at least one raised structure corresponding to the at least one push rib. The magnetic element is disposed on the movable bracket. While the movable bracket is rotated, the at least one raised structure is pushed by the at least one push rib, and the magnetic attraction module is ascended, so that the magnetic element is closer to the upper cover.

In an embodiment, the wireless charging device further includes a power supply module, and the power supply module includes a circuit board and a power cable. The circuit board is arranged between the lower cover and the coil module and electrically connected with the transmitter coil. The power cable is electrically connected with the circuit board.

In an embodiment, a ring-shaped recess is concavely formed in the inner surface of the lower cover, and the movable bracket is accommodated within the ring-shaped recess.

In an embodiment, at least one adjusting rod is installed on a side of the movable bracket facing the lower cover, and at least one adjusting hole is formed in the ring-shaped recess. The at least one adjusting rod is penetrated through the at least one adjusting hole and slidable within the at least one adjusting hole.

In an embodiment, the lower cover further includes at least one positioning rib, and the at least one positioning rib is located at an outside side of the ring-shaped recess. Each of the at least one positioning rib includes at least two positioning bulges.

In an embodiment, the lateral edge of the movable bracket further includes a positioning notch corresponding to the at least two positioning bulges. While the movable bracket is rotated and one of the at least two positioning bulges is engaged with the positioning notch, the magnetic attraction module is positioned.

In an embodiment, each of the at least one push rib includes a slant surface and a top surface. While the movable bracket is rotated, the at least one raised structure is moved to the top surface along the slant surface.

In an embodiment, the lateral edge of the movable bracket further includes an annual rack structure, and the lower cover further includes an adjusting hole beside the movable bracket.

In an embodiment, the wireless charging device further includes an operable element and a transmission gear, and the operable element and the transmission gear are installed on the inner surface of the lower cover. The operable element includes a drive gear and an operable rod. The operable rod is located at an axel center of the drive gear. The operable rod is penetrated through the adjusting hole, and the transmission gear is engaged with the drive gear and the annual rack structure.

In an embodiment, the lateral edge of the movable bracket further includes an annual rack structure.

In an embodiment, the wireless charging device further includes a stepping motor and a transmission gear, and the stepping motor and the transmission gear are installed on the inner surface of the lower cover. The stepping motor includes a drive worm and a motor body, the motor body is connected with the drive worm. The motor body is electrically connected with the circuit board. The transmission gear is engaged with the drive worm and the annual rack structure.

In an embodiment, an adjusting switch is installed on a bottom surface of the circuit board, and the lower cover has an adjusting hole. In addition, the adjusting hole is aligned with the adjusting switch.

In accordance with another aspect of the present invention, a wireless charging device is provided. The wireless charging device includes a housing, a coil module, a magnetic attraction module and an adjusting module. The housing includes an upper cover and a lower cover. An adjusting hole is formed in the lower cover. The magnetic attraction module includes a movable bracket and a magnetic element. The movable bracket includes a disc-shaped part and a connection part. The disc-shaped part has at least one opening. The connection part has a regulating tapped hole. The regulating tapped hole is aligned with the adjusting hole. The magnetic element is installed on the movable bracket. The coil module is located over the movable bracket. The coil module includes a coil bracket and a transmitter coil. The magnetic element is arranged around the coil module. The coil bracket includes at least one supporting structure. The at least one supporting structure is penetrated through the at least one opening and fixed on the lower cover. The transmitter coil is installed on the coil bracket. The adjusting module is rotatably installed in the adjusting hole. An end of the adjusting module is engaged with the regulating tapped hole. While the adjusting module is rotated, the movable bracket is moved upwardly or downwardly by the adjusting module through the connection part of the movable bracket. Consequently, the magnetic element is moved in a direction close to or away from the upper cover.

In an embodiment, the wireless charging device further includes a power supply module, and the power supply module includes a circuit board and a power cable. The circuit board is arranged between the lower cover and the movable bracket and electrically connected with the transmitter coil. The power cable is electrically connected with the circuit board.

In an embodiment, at least one coupling rib is formed on an inner surface of the lower cover. The at least one coupling rib is aligned with the at least one opening and engaged with the at least one supporting structure.

In an embodiment, the adjusting module includes an inner knob and an outer knob. The inner knob is installed on an inner surface of the lower cover. The outer knob is installed on an outer surface of the lower cover. The inner knob includes a pedestal, a threaded rod and a polygonal sheath hole. The outer knob includes a knob body and a polygonal connection rod. The threaded rod is connected with the pedestal, the polygonal sheath hole is located at an end of the pedestal. The polygonal connection rod is located at an axel center of the knob body.

In an embodiment, the polygonal connection rod is penetrated through the adjusting hole and engaged with the polygonal sheath hole, and the threaded rod is engaged with the regulating tapped hole.

In an embodiment, a dent is formed in the inner surface of the lower cover and aligned with the adjusting hole, wherein the pedestal is accommodated within the dent.

From the above descriptions, the wireless charging device of the present invention is advantageous over the conventional wireless charging device. The altitude of the magnetic attraction module in the wireless charging device of the present invention can be adjusted according to the preference or the need of the user. Consequently, the strength of the magnetic attraction force is adjustable. In addition, the magnetic attraction force can be adjusted in a two-stage manner or a multi-stage manner. Consequently, different types and specifications of portable electronic devices can be securely and magnetically attracted on the wireless charging device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic perspective view illustrating a wireless charging device according to a first embodiment of the present invention;

FIG. 1B is a schematic perspective view illustrating the wireless charging device according to the first embodiment of the present invention and taken along another viewpoint;

FIG. 1C is a schematic exploded view illustrating the wireless charging device according to the first embodiment of the present invention;

FIGS. 2A and 2B schematically illustrate the actions of the magnetic attraction module according to the first embodiment of the present invention;

FIG. 3A is a schematic perspective view illustrating a wireless charging device according to a second embodiment of the present invention;

FIG. 3B is a schematic perspective view illustrating the wireless charging device according to the second embodiment of the present invention and taken along another viewpoint;

FIG. 3C is a schematic exploded view illustrating the wireless charging device according to the second embodiment of the present invention;

FIG. 4 schematically illustrates the action of the magnetic attraction module according to the second embodiment of the present invention;

FIG. 5A is a schematic perspective view illustrating a wireless charging device according to a third embodiment of the present invention;

FIG. 5B is a schematic perspective view illustrating the wireless charging device according to the third embodiment of the present invention and taken along another viewpoint;

FIG. 5C is a schematic exploded view illustrating the wireless charging device according to the third embodiment of the present invention;

FIG. 6A is a schematic cutaway view illustrating the wireless charging device according to the third embodiment of the present invention;

FIG. 6B schematically illustrates the action of the magnetic attraction module according to the third embodiment of the present invention;

FIG. 7A is a schematic perspective view illustrating a wireless charging device according to a fourth embodiment of the present invention;

FIG. 7B is a schematic perspective view illustrating the wireless charging device according to the fourth embodiment of the present invention and taken along another viewpoint;

FIG. 7C is a schematic exploded view illustrating the wireless charging device according to the fourth embodiment of the present invention; and

FIG. 8 schematically illustrates the action of the magnetic attraction module according to the fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

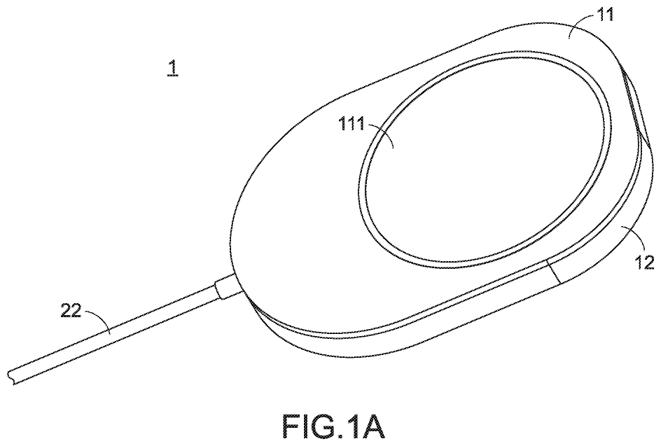

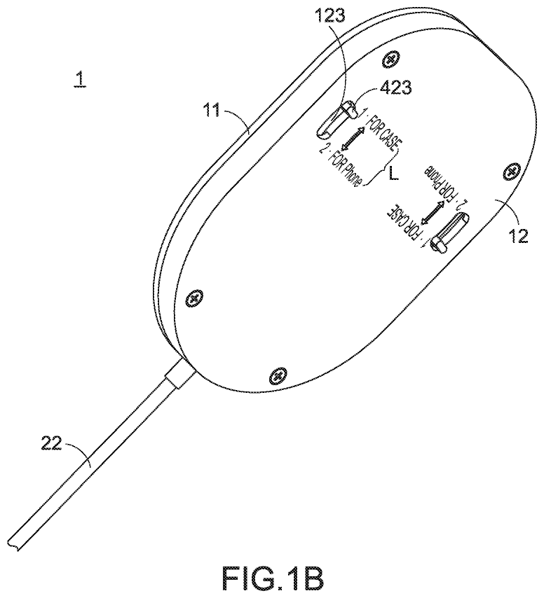

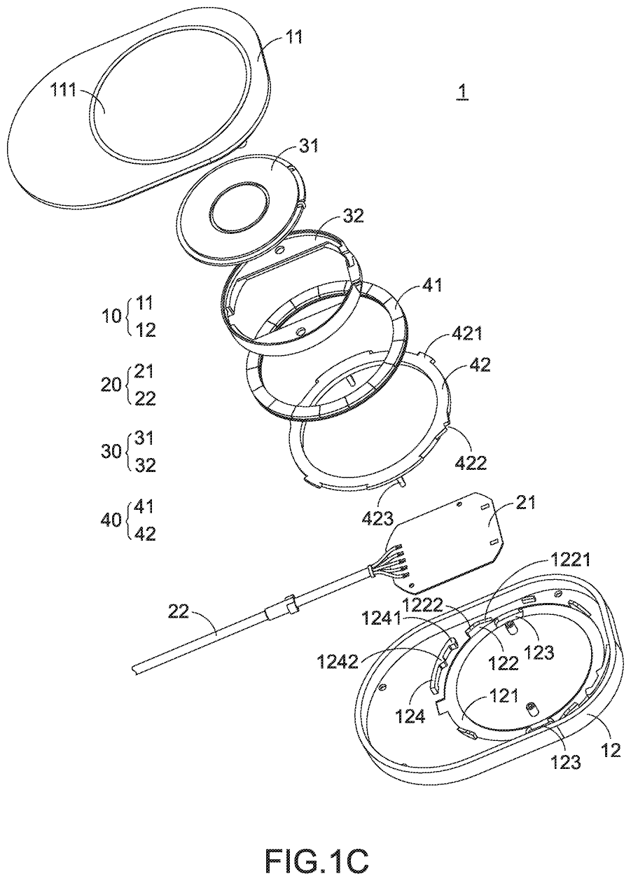

Please refer to FIGS. 1A, 1B and 1C. FIG. 1A is a schematic perspective view illustrating a wireless charging device according to a first embodiment of the present invention. FIG. 1B is a schematic perspective view illustrating the wireless charging device according to the first embodiment of the present invention and taken along another viewpoint. FIG. 1C is a schematic exploded view illustrating the wireless charging device according to the first embodiment of the present invention.

In this embodiment, the wireless charging device 1 comprises a housing 10, a power supply module 20, a coil module 30 and a magnetic attraction module 40.

The housing 10 comprises an upper cover 11 and a lower cover 12. After the upper cover 11 and the lower cover 12 are combined together, an accommodation space is defined. The power supply module 20, the coil module 30 and the magnetic attraction module 40 are disposed within the accommodation space. Moreover, a ring-shaped recess 121 is concavely formed in an inner surface of the lower cover 12. A push rib 122 and a positioning rib 124 are arranged around the ring-shaped recess 121. At least one adjusting hole 123 runs through the ring-shaped recess 121. Moreover, at least one indication symbol L representing the height status of the magnetic attraction module 40 is formed on an outer surface of the lower cover 12 and located beside the corresponding adjusting hole 123. For example, as shown in FIG. 1B, the at least one indication symbol L includes “FOR CASE” and “FOR PHONE”. In an embodiment, the push rib 122 comprises a slant surface 1221 and a top surface 1222. The positioning rib 124 comprises two adjacent positioning bulges 1241 and 1242 at the side facing the ring-shaped recess 121. Moreover, the upper cover 11 has a power supply platform 111 for placing a portable electronic device (not shown) thereon.

The power supply module 20 comprises a circuit board 21 and a power cable 22. The circuit board 21 is installed on a middle region of the ring-shaped recess 121 of the lower cover 12. A first terminal of the power cable 22 is electrically connected with the circuit board 21. A second terminal of the power cable 22 is protruded outside the housing 10 and connected with an external power source (not shown). For example, the external power source is a power socket or a power bank.

The coil module 30 is installed on the lower cover 12 and located over the circuit board 21. The coil module 30 comprises a transmitter coil 31 and a coil bracket 32. The coil bracket 32 is fixed on the lower cover 12. The transmitter coil 31 is installed on the coil bracket 32. The transmitter coil 31 is electrically connected with the circuit board 21 through a conducting line (not shown). Moreover, the installation position of the transmitter coil 31 is aligned with the power supply platform 111 of the upper cover 11.

The magnetic attraction module 40 is arranged around the coil module 30. In addition, the magnetic attraction module 40 is not interfered with the coil module 30. In an embodiment, the magnetic attraction module 40 comprises a magnetic element 41 and a movable bracket 42. The magnetic element 41 is a ring-shaped magnet and disposed on the movable bracket 42. The lateral edge of the movable bracket 42 comprises a raised structure 421 and a positioning notch 422. The raised structure 421 is aligned with the push rib 122. The positioning notch 422 is aligned with the positioning bulges 1241 and 1242 of the positioning rib 124. Moreover, two adjusting rods 423 are installed on the side of the movable bracket 42 facing the lower cover 12. The movable bracket 42 can be installed in the ring-shaped recess 121. In addition, the movable bracket 42 is rotatably installed on the lower cover 12. Moreover, the two adjusting rods 423 are respectively penetrated through the two adjusting holes 123 and slid within the corresponding adjusting holes 123. The end of the adjusting rod 423 away from the movable bracket 42 is penetrated through the corresponding adjusting hole 123 and partially exposed outside the outer surface of the lower cover 12 (see FIG. 1B). The user can operate the adjusting rod 423 to rotate the movable bracket 42 in order to adjust the position of the magnetic attraction module 40.

In the above embodiment, the magnetic element 41 is a ring-shaped magnet. It is noted that the example of the magnetic element 41 is not restricted. For example, in another embodiment, the magnetic element 41 comprises plural magnets. The number of the magnets, the shapes of the magnets and the spacing interval between any two adjacent magnets may be varied according to the practical requirements.

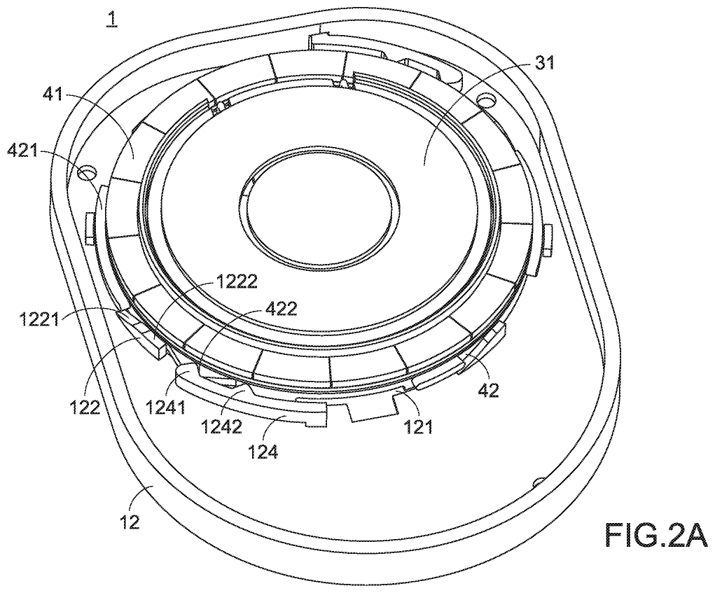

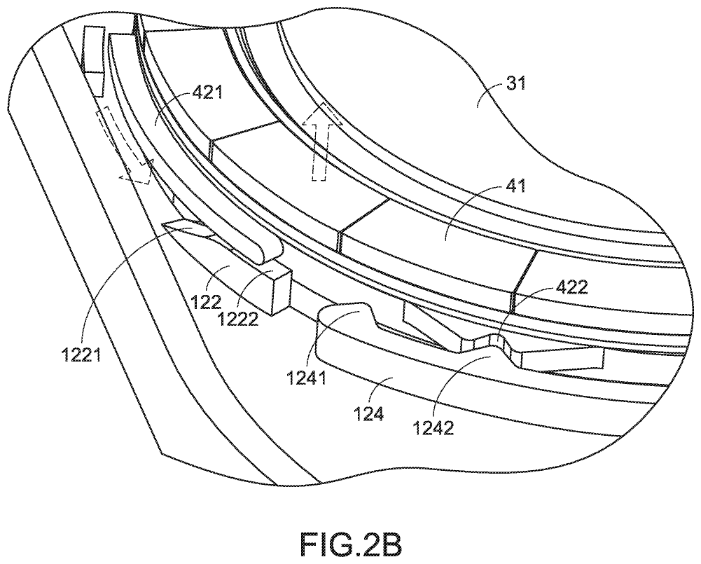

FIGS. 2A and 2B schematically illustrate the actions of the magnetic attraction module according to the first embodiment of the present invention.

Please refer to FIG. 2A. When the adjusting rod 423 is moved to the position corresponding to the indication symbol L “FOR PHONE” (see FIG. 1B), the raised structure 421 is not pushed by the push rib 122. Meanwhile, the positioning notch 422 is engaged with the positioning bulge 1241. Consequently, the magnetic attraction module 40 is positioned at the lowest altitude.

Please refer to FIG. 2B. When the adjusting rod 423 is moved to the position corresponding to the indication symbol L “FOR CASE”, the raised structure 421 is pushed by the push rib 122. During the pushing process, the raised structure 421 is against the slant surface 1221 and moved toward the top surface 1222 along the slant surface 1221. Consequently, the magnetic attraction module 40 is ascended by the push rib 122, and the magnetic element 41 is closer to the upper cover 11. When the raised structure 421 is moved to the top surface 1222 of the push rib 12, the positioning notch 422 is engaged with the positioning bulge 1242. Consequently, the magnetic attraction module 40 is positioned at the highest altitude.

As mentioned above, the altitude of the magnetic attraction module 40 in the wireless charging device 1 of the present invention is adjustable. Consequently, the magnetic element 41 of the magnetic attraction module 40 can be moved in the direction away from the upper cover 11 or close to the upper cover 11. In this way, the strength of the magnetic attraction force between the magnetic attraction module 40 and the portable electronic device is adjustable. In case that the portable electronic device with the general protective case (i.e., the protective case without the magnetic attraction function) is placed on the wireless charging device 1 by the user, the magnetic attraction module 40 can be positioned at the highest altitude to increase the strength of the magnetic attraction force. Consequently, the portable electronic device with the general protective case can be securely placed on the wireless charging device 1, and the wireless charging efficiency is enhanced.

Whereas, in case that the portable electronic device without the general protective case or the portable electronic device with the protective case having the magnetic attraction function is placed on the wireless charging device 1 by the user, the magnetic attraction module 40 can be positioned at the lowest altitude to decrease the strength of the magnetic attraction force. Consequently, the user can remove the portable electronic device from the wireless charging device 1 more easily.

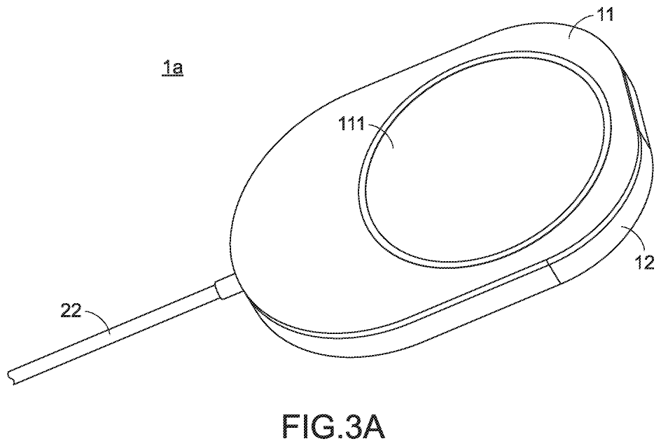

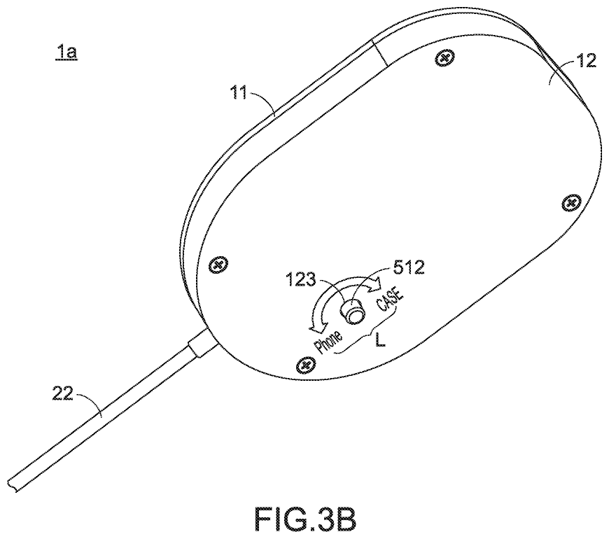

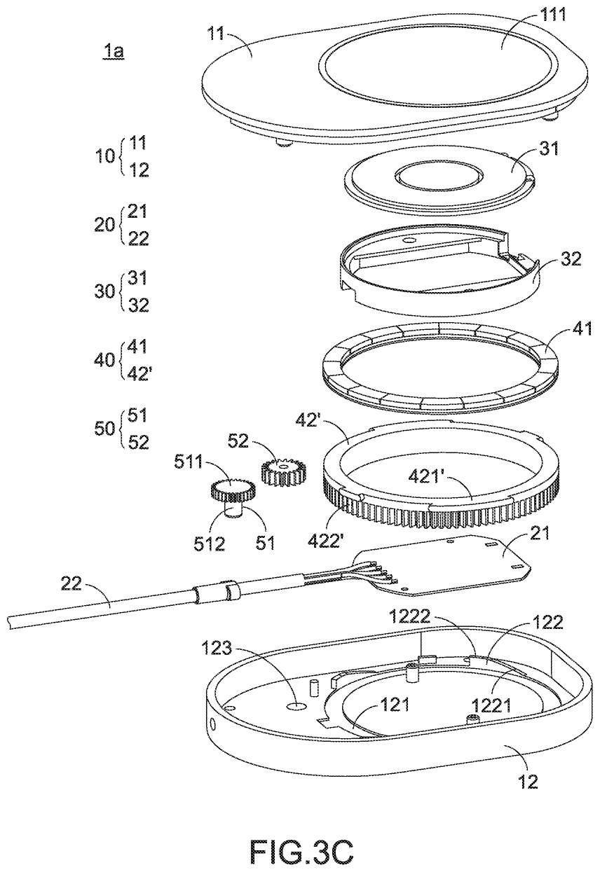

Please refer to FIGS. 3A, 3B and 3C. FIG. 3A is a schematic perspective view illustrating a wireless charging device according to a second embodiment of the present invention. FIG. 3B is a schematic perspective view illustrating the wireless charging device according to the second embodiment of the present invention and taken along another viewpoint. FIG. 3C is a schematic exploded view illustrating the wireless charging device according to the second embodiment of the present invention.

In this embodiment, the wireless charging device 1a also comprises a housing 10, a power supply module 20, a coil module 30 and a magnetic attraction module 40. The functions and installation ways of the housing 10, the power supply module 20, the coil module 30 and the magnetic attraction module 40 of the wireless charging device 1a of this embodiment are similar to those of the wireless charging device 1 of the first embodiment, and not redundantly described herein. In comparison with the first embodiment, the wireless charging device 1a of this embodiment further comprises an adjusting module 50. The adjusting module 50 comprises an operable element 51 and a transmission gear 52. The operable element 51 comprises a drive gear 511 and an operable rod 512. The operable rod 512 is located at the axel center of the drive gear 511.

The lateral edge of the movable bracket 42′ comprises a raised structure 421′. The movable bracket 42′ further comprises an annual rack structure 422′ beside the raised structure 421′. Unlike the first embodiment, the lower cover 12 of the wireless charging device 1a of this embodiment is not equipped with the positioning rib 124. In addition, the adjusting hole 123 of the lower cover 12 is located beside the movable bracket 42′.

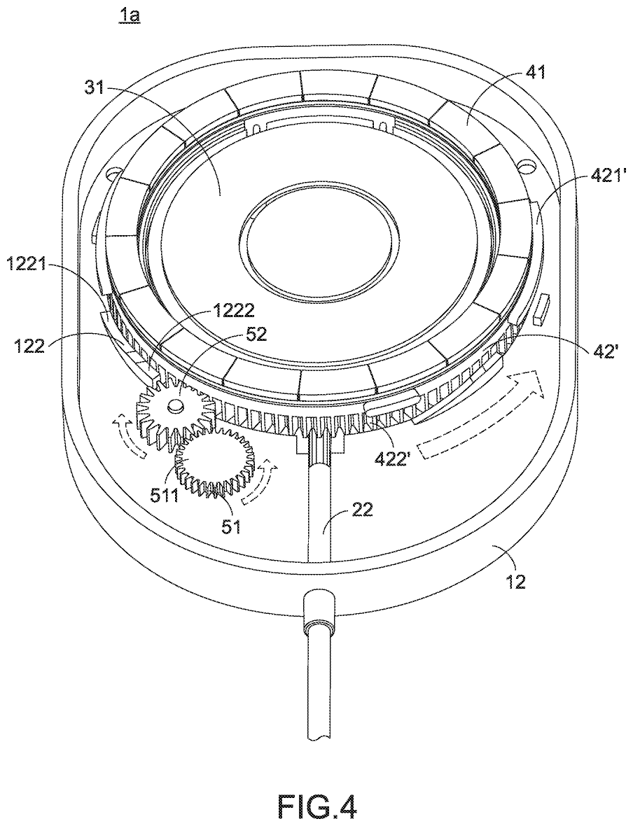

Please refer to FIGS. 3C and 4. FIG. 4 schematically illustrates the action of the magnetic attraction module according to the second embodiment of the present invention. In this embodiment, the operable element 51 and the transmission gear 52 of the adjusting module 50 are installed on the inner surface of the lower cover 12. The operable rod 512 of the operable element 51 is penetrated through the adjusting hole 123 of the lower cover 12. In addition, the end of the operable rod 512 away from the drive gear 511 is partially exposed outside the outer surface of the lower cover 12 (see FIG. 3B). Moreover, the transmission gear 52 is engaged with the drive gear 511 and the annual rack structure 422′.

Please refer to FIG. 4 again. When the operable rod 512 is rotated by the user through the adjusting hole 123, the drive gear 511 is synchronously rotated with the operable rod 512. As the drive gear 511 is rotated, the transmission gear 52 is rotated. Consequently, the movable bracket 42′ is driven to rotate by the annual rack structure 422′ and the transmission gear 52. While the movable bracket 42′ is rotated, the raised structure 421′ is pushed by the push rib 122. Consequently, the raised structure 421′ is moved toward the top surface 1222 along the slant surface 1221. The operations are similar to those of FIG. 2B. In this way, the magnetic attraction module 40 is ascended by the push rib 122, and the magnetic element 41 is closer to the upper cover 11. Consequently, the magnetic attraction force between the magnetic attraction module 40 and the portable electronic device increases.

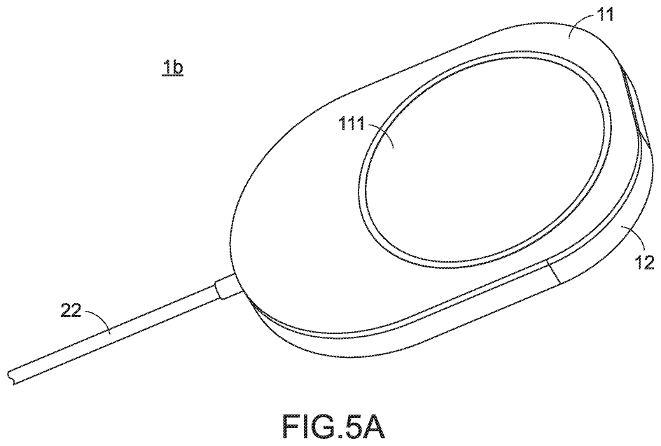

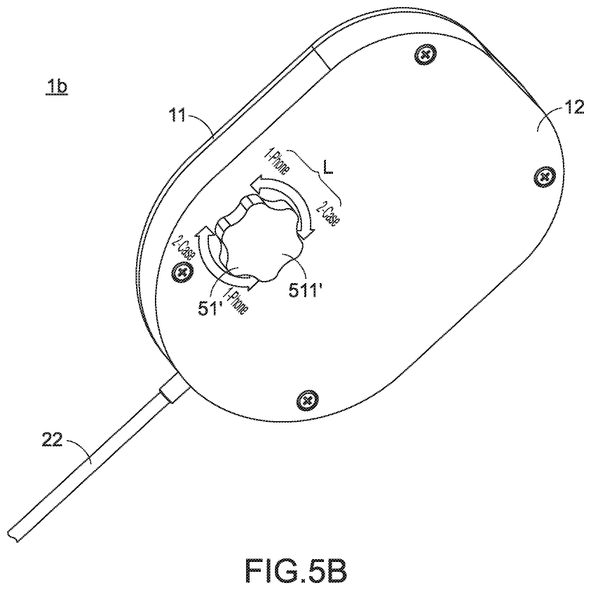

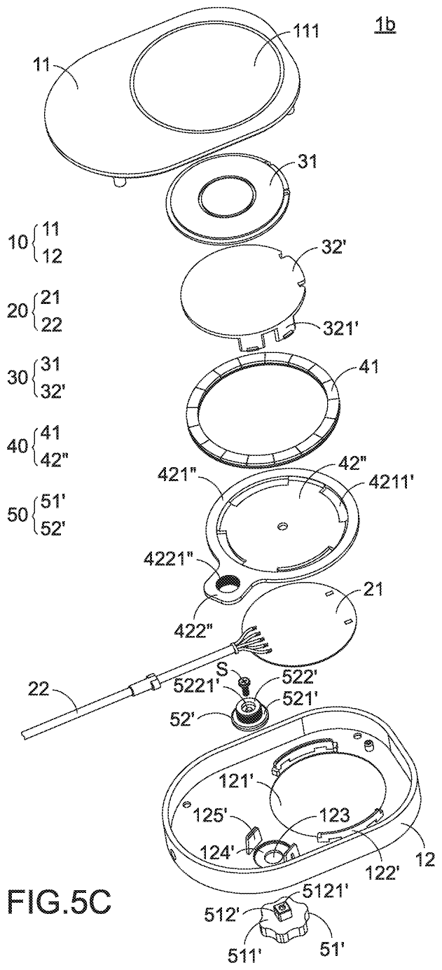

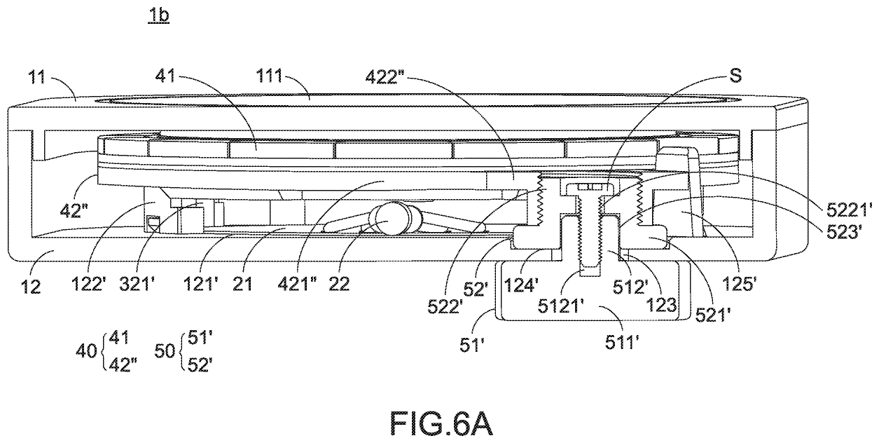

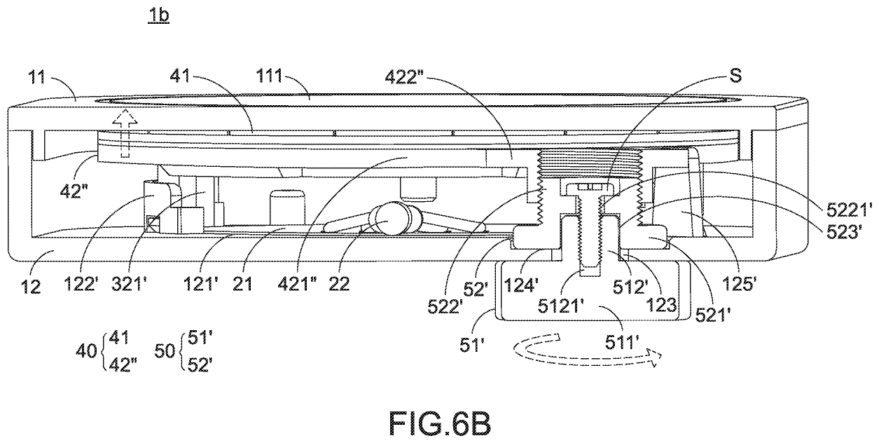

Please refer to FIGS. 5A, 5B, 5C and 6A. FIG. 5A is a schematic perspective view illustrating a wireless charging device according to a third embodiment of the present invention. FIG. 5B is a schematic perspective view illustrating the wireless charging device according to the third embodiment of the present invention and taken along another viewpoint. FIG. 5C is a schematic exploded view illustrating the wireless charging device according to the third embodiment of the present invention. FIG. 6A is a schematic cutaway view illustrating the wireless charging device according to the third embodiment of the present invention. The wireless charging device 1b comprises a housing 10, a power supply module 20, a coil module 30, a magnetic attraction module 40 and an adjusting module 50.

In this embodiment, the lower cover 12 comprises a recess 121′, a coupling rib 122′, an adjusting hole 123, a dent 124′ and at least two position-limiting ribs 125′. The circuit board 21 is accommodated within the recess 121′. The coupling rib 122′ is located at the outer periphery of the recess 121′. Moreover, the dent 124′ is formed in the inner surface of the lower cover 12 and aligned with the adjusting hole 123. The position-limiting ribs 125′ are located at the outer periphery of the dent 124′.

In this embodiment, the adjusting module 50 comprises an outer knob 51′ and an inner knob 52′. The outer knob 51′ is installed on the outer surface of the lower cover 12. The outer knob 51′ comprises a knob body 511′ and a polygonal connection rod 512′. The polygonal connection rod 512′ is located at the axel center of the knob body 511′. The end of the polygonal connection rod 512′ away from the knob body 511′ has a first tapped hole 5121′. The inner knob 52′ is installed on the inner surface of the lower cover 12. The inner knob 52′ comprises a pedestal 521′, a threaded rod 522′ and a polygonal sheath hole 523′ (see FIG. 6A). The threaded rod 522′ is connected with the pedestal 521′. The polygonal sheath hole 523′ is located at an end of the pedestal 521′. The end of the threaded rod 522′ away from the pedestal 521′ has a second tapped hole 5221′. The second tapped hole 5221′ and the polygonal sheath hole 523′ are in communication with each other.

A process of installing the adjusting module 50 will be described as follows. Firstly, the pedestal 521′ is accommodated within the dent 124′ of the lower cover 12. Then, the polygonal connection rod 512′ of the outer knob 51′ is penetrated through the adjusting hole 123 and engaged with the polygonal sheath hole 523′. Then, a fastening element S (e.g., a screw) is penetrated through the second tapped hole 5221′ of the inner knob 52′ and tightened into the first tapped hole 5121′ of the outer knob 51′. Consequently, the outer knob 51′ and the inner knob 52′ are combined together. In this way, the adjusting module 50 is installed in the adjusting hole 123.

The magnetic attraction module 40 comprises a magnetic element 41 and a movable bracket 42″. The movable bracket 42″ comprises a disc-shaped part 421″ and a connection part 422″. The connection part 422″ is connected with the disc-shaped part 421″. The disc-shaped part 421″ has plural openings 4211″. The connection part 422″ has a regulating tapped hole 4221″. The magnetic element 41 is installed on the movable bracket 42″ and located at the edge of the disc-shaped part 421″.

A process of installing the magnetic attraction module 40 will be described as follows. Firstly, the movable bracket 42″ is located over the circuit board 21. In addition, the connection part 422″ is arranged between the position-limiting ribs 125′, and the threaded rod 522′ of the inner knob 52′ is engaged with the regulating tapped hole 4221″ of the movable bracket 42″. In this embodiment, the horizontal movement of the connection part 422″ is limited by the position-limiting ribs 125′. The openings 4211″ of the disc-shaped part 421″ are aligned with the corresponding coupling rib 122′ of the lower cover 12.

In this embodiment, the threaded rod 522′ is combined with the movable bracket 42″ to support the movable bracket 42″. It is noted that this embodiment may be modified according to the practical requirements. For example, in a variant example, one or more elastic elements (e.g., springs) are arranged between the movable bracket 42″ and the lower cover 12 to provide additional elastic supporting force to the movable bracket 42″.

The coil module 30 comprises a transmitter coil 31 and a coil bracket 32′. Moreover, plural supporting structures 321′ are downwardly protruded from the coil bracket 32′. The transmitter coil 31 is installed on the coil bracket 32′.

A process of installing the coil module 30 will be described as follows. Firstly, the coil module 30 is located over the movable bracket 42″. In addition, the supporting structures 321′ of the coil bracket 32′ are penetrated through the corresponding openings 4211″ of the disc-shaped part 421″. Then, the ends of the supporting structures 321′ away from the transmitter coil 31 are engaged with the corresponding coupling rib 122′. Consequently, the coil bracket 32′ is fixed on the lower cover 12. After the installation of the coil module 30 is completed, the magnetic element 41 is arranged around the coil module 30. In addition, the magnetic element 41 and the coil module 30 are not interfered with each other.

Please refer to FIG. 6B. FIG. 6B schematically illustrates the action of the magnetic attraction module according to the third embodiment of the present invention. While the adjusting module 50 is rotated by the user, the threaded rod 522′ of the adjusting module 50 is rotated within the regulating tapped hole 4221″. Due to the movable engagement between the threaded rod 522′ and the regulating tapped hole 4221″, the connection part 422″ is correspondingly moved. As the connection part 422″ is moved, the movable bracket 42″ is moved upwardly or downwardly. In other words, the magnetic element 41 is moved in the direction close to or away from the upper cover 11.

As mentioned above in the first embodiment and the second embodiment, the magnetic attraction module 40 is pushed by the push rib 122. Consequently, the magnetic attraction force can be adjusted in two stages. In this embodiment, the altitude of the movable bracket 42″ can be finely tuned through the movable engagement between the threaded rod 522′ and the regulating tapped hole 4221″. Consequently, the magnetic attraction force can be adjusted in multiple stages. Due to this structural design, the magnetic attraction force can be well adjusted according to need or preference of the user.

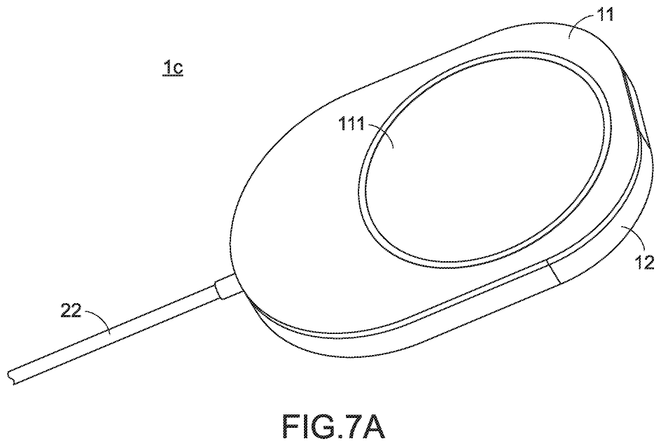

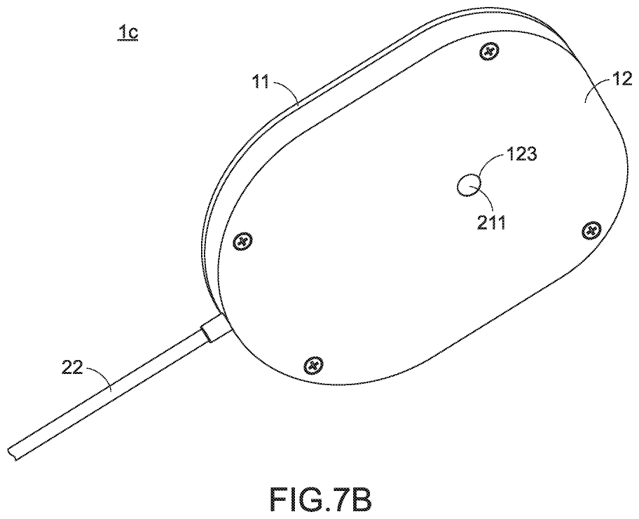

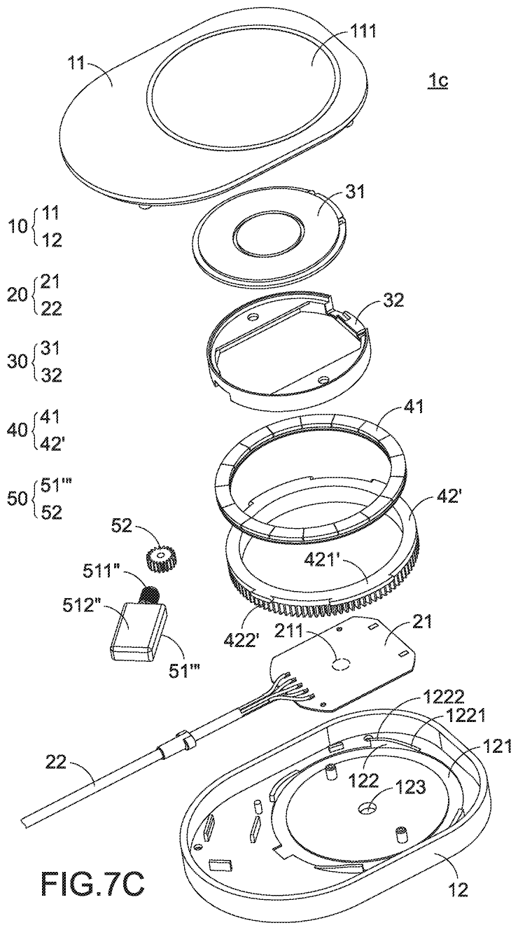

Please refer to FIGS. 7A, 7B and 7C. FIG. 7A is a schematic perspective view illustrating a wireless charging device according to a fourth embodiment of the present invention. FIG. 7B is a schematic perspective view illustrating the wireless charging device according to the fourth embodiment of the present invention and taken along another viewpoint. FIG. 7C is a schematic exploded view illustrating the wireless charging device according to the fourth embodiment of the present invention. The wireless charging device 1c comprises a housing 10, a power supply module 20, a coil module 30 and a magnetic attraction module 40. The functions and installation ways of the housing 10, the power supply module 20, the coil module 30 and the magnetic attraction module 40 of the wireless charging device 1c of this embodiment are similar to those of the wireless charging device 1a of the second embodiment, and not redundantly described herein. In comparison with the second embodiment, the structure of the adjusting module 50 of this embodiment is distinguished.

In his embodiment, the adjusting module 50 comprises a stepping motor 51″ and a transmission gear 52. The stepping motor 51″ and the transmission gear 52 are installed on the inner surface of the lower cover 12. The stepping motor 51″ comprises a drive worm 511″ and a motor body 512″. The motor body 512″ is connected with the drive worm 511″. The motor body 512″ is electrically connected with the circuit board 21 through a conducting line (not shown). Consequently, the motor body 512″ is controlled by the circuit board 21. The transmission gear 52 is engaged with the drive worm 511″ and the annual rack structure 422′. Moreover, an adjusting switch 211 is installed on a bottom surface of the circuit board 21. The adjusting hole 123 of the lower cover 12 is located under the circuit board 21 and aligned with the adjusting switch 211. For example, the adjusting switch 211 is a touch switch.

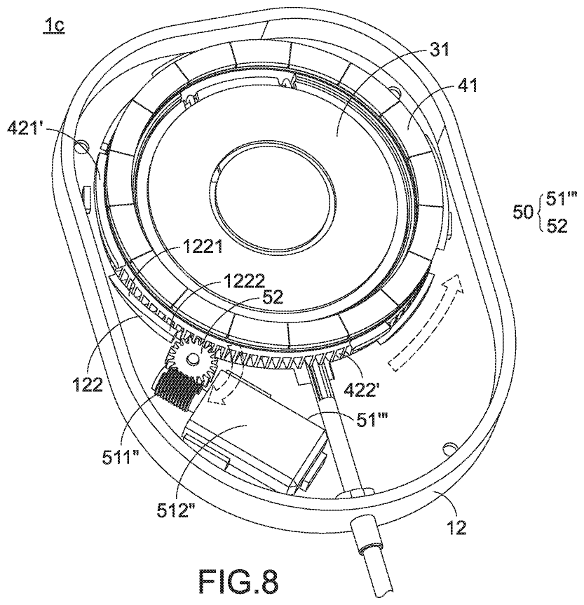

Please refer to FIG. 8. FIG. 8 schematically illustrates the action of the magnetic attraction module according to the fourth embodiment of the present invention. When the adjusting switch 211 is triggered by the user, the motor body 512″ is controlled by the circuit board 21. Consequently, the drive worm 511″ is rotated to drive the rotations of the transmission gear 52 and the annual rack structure 422′. In this way, the movable bracket 42′ is correspondingly rotated.

From the above descriptions, the wireless charging device of the present invention is advantageous over the conventional wireless charging device. The altitude of the magnetic attraction module in the wireless charging device of the present invention can be adjusted according to the preference or the need of the user. Consequently, the strength of the magnetic attraction force is adjustable. In addition, the magnetic attraction force can be adjusted in a two-stage manner or a multi-stage manner. Consequently, different types and specifications of portable electronic devices can be securely and magnetically attracted on the wireless charging device. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A wireless charging device, comprising:
a housing comprising an upper cover and a lower cover, wherein at least one push rib is formed on an inner surface of the lower cover;
a coil module installed on the lower cover, and comprising a coil bracket and a transmitter coil, wherein the coil bracket is fixed on the lower cover, and the transmitter coil is installed on the coil bracket; and
a magnetic attraction module arranged around the coil module, and comprising a movable bracket and a magnetic element, wherein the movable bracket is rotatably installed on the lower cover, a lateral edge of the movable bracket comprises at least one raised structure corresponding to the at least one push rib, and the magnetic element is disposed on the movable bracket,
wherein while the movable bracket is rotated, the at least one raised structure is pushed by the at least one push rib, and the magnetic attraction module is ascended, so that the magnetic element is closer to the upper cover.

2. The wireless charging device according to claim 1, wherein the wireless charging device further comprises a power supply module, and the power supply module comprises a circuit board and a power cable, wherein the circuit board is arranged between the lower cover and the coil module and electrically connected with the transmitter coil, and the power cable is electrically connected with the circuit board.

3. The wireless charging device according to claim 1, wherein a ring-shaped recess is concavely formed in the inner surface of the lower cover, and the movable bracket is accommodated within the ring-shaped recess.

4. The wireless charging device according to claim 3, wherein at least one adjusting rod is installed on a side of the movable bracket facing the lower cover, and at least one adjusting hole is formed in the ring-shaped recess, wherein the at least one adjusting rod is penetrated through the at least one adjusting hole and slidable within the at least one adjusting hole.

5. The wireless charging device according to claim 3, wherein the lower cover further comprises at least one positioning rib, and the at least one positioning rib is located at an outside side of the ring-shaped recess, wherein each of the at least one positioning rib comprises at least two positioning bulges.

6. The wireless charging device according to claim 5, wherein the lateral edge of the movable bracket further comprises a positioning notch corresponding to the at least two positioning bulges, wherein while the movable bracket is rotated and one of the at least two positioning bulges is engaged with the positioning notch, the magnetic attraction module is positioned.

7. The wireless charging device according to claim 1, wherein each of the at least one push rib comprises a slant surface and a top surface, wherein while the movable bracket is rotated, the at least one raised structure is moved to the top surface along the slant surface.

8. The wireless charging device according to claim 1, wherein the lateral edge of the movable bracket further comprises an annual rack structure, and the lower cover further comprises an adjusting hole beside the movable bracket.

9. The wireless charging device according to claim 8, wherein the wireless charging device further comprises an operable element and a transmission gear, and the operable element and the transmission gear are installed on the inner surface of the lower cover, wherein the operable element comprises a drive gear and an operable rod, and the operable rod is located at an axel center of the drive gear, wherein the operable rod is penetrated through the adjusting hole, and the transmission gear is engaged with the drive gear and the annual rack structure.

10. The wireless charging device according to claim 2, wherein the lateral edge of the movable bracket further comprises an annual rack structure.

11. The wireless charging device according to claim 10, wherein the wireless charging device further comprises a stepping motor and a transmission gear, and the stepping motor and the transmission gear are installed on the inner surface of the lower cover, wherein the stepping motor comprises a drive worm and a motor body, the motor body is connected with the drive worm, the motor body is electrically connected with the circuit board, and the transmission gear is engaged with the drive worm and the annual rack structure.

12. The wireless charging device according to claim 11, wherein an adjusting switch is installed on a bottom surface of the circuit board, and the lower cover has an adjusting hole, wherein the adjusting hole is aligned with the adjusting switch.

13. A wireless charging device, comprising:
a housing comprising an upper cover and a lower cover, wherein an adjusting hole is formed in the lower cover;
a magnetic attraction module comprising a movable bracket and a magnetic element, wherein the movable bracket comprises a disc-shaped part and a connection part, the disc-shaped part has at least one opening, the connection part has a regulating tapped hole, and the regulating tapped hole is aligned with the adjusting hole, wherein the magnetic element is installed on the movable bracket;
a coil module located over the movable bracket, and comprising a coil bracket and a transmitter coil, wherein the magnetic element is arranged around the coil module, the coil bracket comprises at least one supporting structure, the at least one supporting structure is penetrated through the at least one opening and fixed on the lower cover, and the transmitter coil is installed on the coil bracket; and
an adjusting module rotatably installed in the adjusting hole,
wherein an end of the adjusting module is engaged with the regulating tapped hole, wherein while the adjusting module is rotated, the movable bracket is moved upwardly or downwardly by the adjusting module through the connection part of the movable bracket, so that the magnetic element is moved in a direction close to or away from the upper cover.

14. The wireless charging device according to claim 13, wherein the wireless charging device further comprises a power supply module, and the power supply module comprises a circuit board and a power cable, wherein the circuit board is arranged between the lower cover and the movable bracket and electrically connected with the transmitter coil, and the power cable is electrically connected with the circuit board.

15. The wireless charging device according to claim 13, wherein at least one coupling rib is formed on an inner surface of the lower cover, wherein the at least one coupling rib is aligned with the at least one opening and engaged with the at least one supporting structure.

16. The wireless charging device according to claim 13, wherein the adjusting module comprises an inner knob and an outer knob, wherein the inner knob is installed on an inner surface of the lower cover, the outer knob is installed on an outer surface of the lower cover, the inner knob comprises a pedestal, a threaded rod and a polygonal sheath hole, and the outer knob comprises a knob body and a polygonal connection rod, wherein the threaded rod is connected with the pedestal, the polygonal sheath hole is located at an end of the pedestal, and the polygonal connection rod is located at an axel center of the knob body.

17. The wireless charging device according to claim 16, wherein the polygonal connection rod is penetrated through the adjusting hole and engaged with the polygonal sheath hole, and the threaded rod is engaged with the regulating tapped hole.

18. The wireless charging device according to claim 16, wherein a dent is formed in the inner surface of the lower cover and aligned with the adjusting hole, wherein the pedestal is accommodated within the dent.
